(19) United States
(12) Patent Application Publication
(10) Pub. No.: US 2026/0302781 A1
(43) Pub. Date: Oct. 1, 2026

(54) TRANSFORMER SYSTEM

(71) Applicant: THIRD EQUATION LIMITED, London (GB)

(72) Inventors: Gregory Francis DUJON, London (GB); Paul BLACKBURN, London (GB); Veimar MORENO, London (GB)

(21) Appl. No.: 19/478,389

(22) PCT Filed: Apr. 26, 2024
(86) PCT No.: PCT/EP2024/061589

§ 371 Date: Oct. 24, 2025

(30) Foreign Application Priority Data
Apr. 27, 2023 (GB) 2306247.4

(51) Int. Cl. H02J 3/18; H02J 3/01

(52) U.S. Cl. CPC H02J 3/18; H02J 3/01

(57) ABSTRACT

Transformer systems for electrical power distribution networks A transformer system comprises a distribution transformer configured to receive power from an electrical power distribution network at a distribution voltage and to output electrical power at a regulated voltage. The transformer system also comprises a trimming transformer configured to apply a correction voltage and a correction current, and an energy storage unit configured to receive and store energy from, and provide energy to, the trimming transformer. The transformer system also comprises a power electronics unit configured to control the correction voltage and the correction current applied by the trimming transformer. The power electronics unit is configured to provide one or more of: a voltage regulation effect; a power control effect; a phase balancing effect; a harmonic reduction effect; and a support effect.

### TECHNICAL FIELD

The present disclosure relates to transformer systems, in particular transformer systems for electric power distribution networks.

### BACKGROUND

Electrical power distribution networks (also referred to as electrical grids) are a critical global infrastructure component, responsible for the transfer of power from points of generation (including traditional turbine-based power stations burning fuels such as gas, coal or biomass) to points of use (such as homes and businesses). Typically, the amount of power generated by dispatchable power sources (such as coal, gas and biomass power stations) is controllable; if the same amount of fuel is used on a daily basis the power output from turbine based power station is likely to remain stable. However, the increasing shift towards more renewable energy generation may result in more variation in generated power. Non-dispatchable energy sources such as wind turbine arrays, solar energy installations, wave energy converters and so on may be more unpredictable than turbine-based power stations. The amount of energy generated by a non-dispatchable energy source may vary on a daily or even hourly basis; a wind turbine array will naturally generate less energy on a still day than on an averagely windy day, all else being equal. It is common for non-dispatchable energy sources to generate lower amounts of power per source than traditional dispatchable power stations; accordingly larger numbers of non-dispatchable power sources are required to generate an equivalent amount of power and therefore there may be more points of entry for power into a distribution network.

The increased number of points of entry may cause further variation in power levels across a power distribution network. A further consideration is the likely future increase in the demands placed on power distribution networks. The likely future shift to increased electrification for a broad swathe of applications, including road transport, home heating, industrial processes, and so on, would place increased capacity demands on power distribution network. Increasing capacity by simply installing additional cables and support infrastructure (essentially increasing the size of the power distribution network) may be difficult due to the substantial time and cost requirements; it is therefore desirable to support increased capacity using an existing power distribution network infrastructure with modest additional components. One way to increase the capacity of existing power distribution networks is to improve the efficiency with which the networks deliver power.

The potential increase in generated power variation, and predicted future load increases, pose many challenges to Distribution Network Operators (DNOs). In particular, the reliability of the electricity grid to deliver stable power to homes and businesses may be affected by the ever-increasing amount of de-centralised renewable generation. Further, power distribution systems were originally designed to carry power in only one direction from high voltage to low voltage; the increased adoption of renewable energy sources may violate this assumption. There are several factors which may potentially impact the stability of power supplied by power distribution networks. Examples of the factors which may impact power distribution network stability include: voltage regulation issues; power flow control issues; phase balancing issues and harmonic issues, these factors are discussed in greater detail below.

Typically, DNOs aim or are required by regulation to provide voltage to homes and businesses within a specified range of a target voltage. By way of example, the relevant UK regulations (“Electricity Safety, Quality and Continuity Regulations”, published by the UK government and available at https://www.legislation.gov.uk/uksi/2002/2665/contents/made as of 20 Mar. 2023) require that power be provided at 230V-6%/+10%, which equates to a voltage range of 216.2-253V. Providing voltages to homes and businesses consistently within a specified range may be comparatively straightforward when the generation of power is predictable; as explained above this is not necessarily the case where non-dispatchable energy sources with more variable power output levels provide some or all of the power generation capacity. Accordingly, where non-dispatchable energy sources are used, DNOs may be at risk of not satisfying voltage range requirements.

Power control issues, particularly those relating to reactive power at a load (for example, a business) may also cause instability in power systems. Essentially, reactive power equates to the inefficient delivery of power, caused by the release of energy stored by inductive and capacitive loads, which produces a phase difference between the voltage and current waveform and can therefore cause power to flow in the opposite direction to that intended (that is, from the load back towards the network). The ideal case is that a power factor (Pf) is equal to 1 (also referred to as a unity power factor). When power factor is not in the ideal case, it takes more current from the perspective of the DNO to supply the same amount of voltage to points of use. FIG. 1 illustrates the differences between systems with unity and non-unity power factors. In FIG. 1 the x axes indicate time variation, while the y axes indicate normalised voltage and current variation. Normalised lines indicate voltage and current variation. A unity power factor is shown in FIG. 1A, while FIG. 1B shows a non-unity power factor. A consequence of the non-unity power factor (as shown in FIG. 1B) is that the current shifts out of phase with the voltage, accordingly the power delivery efficiency is reduced. Existing systems may attempt to reduce reactive power effects on power systems using banks of capacitors which may provide a current to compensate for reactive power at loads.

Phase balancing issues may arise in any system involving multiple phases, for example, three phase systems. The ideal case of any multiple phase power system is for the phases to be balanced. Where the phases are balanced, voltage or current measurements over each phase should be sinusoidal, with each phase equal in magnitude and wherein there are equal phase differences between the phases (for example, in a three-phase system, 120° of phase difference between the phases). Conversely, unbalanced conditions arise when either the phase magnitudes are different, or the phases difference are not equal, or both.

FIG. 2 illustrates the differences between systems with balanced and unbalanced phases; in the example shown in FIG. 2, a three-phase system is illustrated. In FIG. 2 the x axes show time variation, while the y axes show voltage variation. The three phases are shown in FIG. 2 using lines having different dash patterns to one another. The balanced phases in the FIG. 2A plot are of equal peak (voltage) magnitude and equally spaced; by contrast the unbalanced phases in the FIG. 2B plot are neither equal in peak magnitude nor equally spaced. Unbalanced phases may arise from short-term situations such as fault currents through the system, or long-term situations such as unbalanced overhead transmission lines at high voltage continuously transferring this unbalance to the low voltage supply system or caused by loads on low voltage supply systems drawing harmonics. Loads creating unbalanced phases in a low voltage supply system will subsequently create problems for distribution transformers by creating inefficient delivery of power from the distribution transformers.

Harmonics issues in power systems typically result from the design and/or operation of non-linear equipment (such as domestic appliances and motorised equipment, for example). Harmonics introduce modulation of the voltage or current at integer multiples of the fundamental frequency; for example, on a 50 Hz system, a 3rd harmonic may introduce an additional 150 Hz component on top of the fundamental 50 Hz waveform. A comparison of a harmonic waveform and fundamental waveform is shown in FIG. 3. The x axis of FIG. 3 shows time variation, while the y axis shows voltage variation. As can be seen the ideal, sinusoidal voltage waveform (solid line, Vₕ) is distorted by the presence of harmonics, resulting in the harmonic modulated voltage waveform (dashed line, V_{ref}). Distortion of the type illustrated by the harmonic modulated voltage waveform may result in detrimental impacts on equipment. These impacts may include the overheating of components, equipment, and insulation in cabling, as a consequence of which such equipment can deteriorate quicker than otherwise projected. In the context of a distribution substation in a power distribution network, harmonics may result in poor quality power for users in homes and businesses. Typically, power distribution networks aim to maintain levels of harmonic distortion below agreed thresholds, for example those set by the British Standards Institution (BSI) in “BS EN 61000: Electromagnetic Compatibility (EMC) Limits. Part 3-12: Limits for harmonic currents produced by equipment connected to public low-voltage systems with input current >16 A and ≤75 A per phase”, available at https://landingpage.bsigroup.com/LandingPage/Series?UPI=BS % 20EN %2061000 as of 20 Mar. 2023. Known methods for reducing harmonic distortion include equipment known as harmonic filters. Harmonic filters are made up of resistors, inductors, and capacitors and are also referred to as RLC filters. RLC filters are tuned to reduce either specific harmonics or a range of harmonics.

As mentioned above, systems and techniques exist for supporting stable power supply from power distribution networks. Voltage control may be provided through the installation of on load tap changers (OLTC), which may be installed on transformers to provide voltage control to substations. OLTCs act to adjust the sending voltage in fixed increments (typically using mechanical switching), thereby providing some degree of responsiveness to voltage driven demands. Typically, OLTC may support response times of the order of tens of seconds to tens of minutes. Voltage control may also be provided using a Line Voltage (LV) regulator; a single-phase transformer which is placed mid-line. A LV regulator, like an OLTC may support response times of the order of tens of seconds to tens of minutes. LV regulators may also provide some support for power loss reduction through voltage minimisation.

Reactive power flow management may be provided using switchable capacitors (typically arrayed in banks), which may be used to manage reactive power flows that may otherwise cause voltage issues such as voltage drops in networks. Switchable capacitors may also be used to provide some mitigation of power quality issues such as low power factors (see below). By injecting power back into the network (within the constraints allowed by the capacitor values available), a switchable capacitor bank may allow different levels of capacitance to be coupled to the network, and may thereby improve the power factor of a power distribution network. Switchable capacitors may also act to reduce power harmonics in the network (again, within the limits allowed by the capacitors available in the capacitor bank).

Further support for stabilising power supplies from power distribution networks may come in the form of monitoring. By way of example, monitoring may be performed at substations stepping down higher network voltages (for example, 11 kV) to low voltages (for example, 450V or 230V) for business or domestic use. Monitoring may additionally or alternatively be performed at the midpoints and/or endpoints of low voltage portions of a power distribution network, to ensure voltage levels remain within acceptable limits across the entire length of the network. The use of network monitoring can provide network operators with improved understanding of the capabilities of the networks, allowing more accurate predictions of network performance. The potential to provide control signals to other systems, such as OLTCs, LV regulators and so on, to allow rapid correction of voltage issues also exists.

Through the use of OLTC, LC regulators, switchable capacitors, monitoring, and so on, it is possible to mitigate some of the factors which may impact power distribution network stability and/or efficiency. However, the capabilities of several of the above systems to react rapidly to developing issues is limited. It is common for available installation space around power distribution network equipment to be restricted; accordingly installation of multiple separate systems may not be straightforward or possible.

### SUMMARY

It is desirable to facilitate the management of grid stability to ensure continuous and predictable power supplies to power users, and to mitigate the impacts of any interruptions that do occur. In particular, it is desirable to provide network power transformer systems that may assist with the stability and reliability of power supplies to users. It is also desirable to reduce the amount of additional systems required, and to protect power distribution networks from inefficiencies caused by load properties.

The summary is provided to introduce a selection of concepts in a simplified form that are further described below in the detailed description. The summary is not intended to identify key features or essential features of the claimed subject matter, nor is it intended to be used to limit the scope of the claimed subject matter. For the avoidance of doubt, the scope of the claimed subject matter is defined by the claims.

Embodiments of the disclosure provide transformer systems for electrical power distribution networks. A transformer system comprises a trimming transformer configured to receive at an input connection power from an electrical power distribution network at a distribution voltage, to apply a correction voltage and a correction current to the input connection power and to output at an output connection corrected power. The transformer system further comprises a distribution transformer connected in series with the output connection of the trimming transformer and configured to receive the corrected power from the trimming transformer and to output electrical power at a regulated voltage. The transformer system also comprises an energy storage unit connected to the trimming transformer and configured to receive energy from the trimming transformer and store the received energy, and to provide energy to the trimming transformer from stored energy. The transformer system also comprises a power electronics unit configured to monitor the input connection power from the electrical power distribution network, and to control the correction voltage and the correction current applied by the trimming transformer based on the properties of the monitored input connection power. The power electronics unit is configured to control at least one of the correction voltage and the correction current to provide one or more of: a voltage regulation effect; a power control effect; a phase balancing effect; a harmonic reduction effect; and a support effect.

A further transformer system comprises a distribution transformer configured to receive at an input connection power from an electrical power distribution network at a distribution voltage and to output electrical power at a regulated voltage. The transformer system further comprises a trimming transformer connected in series with the output connection of the distribution transformer and configured to receive at an input connection the output power at the regulated voltage from the distribution transformer, to apply a correction voltage and a correction current to the input connection power and to output at an output connection corrected power. The transformer system also comprises an energy storage unit connected to the trimming transformer and configured to receive energy from the trimming transformer and store the received energy, and to provide energy to the trimming transformer from stored energy. The transformer system also comprises a power electronics unit configured to monitor the power at the trimming transformer input, and to control the correction voltage and the correction current applied by the trimming transformer based on the properties of the monitored input connection power. The power electronics unit is configured to control at least one of the correction voltage and the correction current to provide one or more of: a voltage regulation effect; a power control effect; a phase balancing effect; a harmonic reduction effect; and a support effect.

In some embodiments, the power electronics unit may be configured to monitor at least one of: the magnitude of the input connection power; the input connection voltage sign and magnitude; the input connection current magnitude; the input connection current phase; harmonic modulations in input connection current and/or voltage; input frequency; and power factor angle. The power electronics unit may be connected to at least one current sensor and at least one voltage sensor, and may be configured to utilise the at least one current sensor and at least one voltage sensor to monitor the input connection power from the electrical power distribution network.

In some embodiments, the power electronics unit may be configured to control at least one of the correction voltage and the correction current to provide one or more of: a voltage regulation effect; a power control effect; a phase balancing effect; a harmonic reduction effect; and a support effect.

In some embodiments, the input connection may be a three-phase connection and the trimming transformer may be configured to receive three phase power via the three-phase connection, or wherein the input connection may be a single-phase connection and the trimming transformer may be configured to receive single phase power via the single-phase connection. Where the input connection is a three-phase connection, the correction current and connection voltage to be applied by the trimming transformer may be calculated by the power electronics unit as vector sums configured to provide one or more effects.

In some embodiments, the transformer system may further comprising a transceiver, and the transformer system may be configured to initiate transmission of power status reports via the transceiver, and/or to receive power control instructions via the transceiver. The transformer system may also or alternatively be configured to interact with one or more further transformer systems to provide collective network effects.

In some embodiments, the transformer system may be configured to control each phase of a plural phase power input separately. Further for each phase of the plural phase power input the transformer system may comprises a Flexible Active Control Transmission System (FACTS) configured to allow adjustment of the properties of the phase.

In some embodiments where plural FACTS are used, one or more of the FACTS may comprise a series converter and a shunt converter.

### BRIEF DESCRIPTION OF DRAWINGS

For a better understanding of the present disclosure, and to show how it may be put into effect, reference will now be made, by way of example only, to the accompanying drawings, in which:

FIG. 1 illustrates the differences between systems with unity and non-unity power factors;

FIG. 2 illustrates the differences between systems with balanced and unbalanced phases;

FIG. 3 shows a comparison of a harmonic waveform and fundamental waveform;

FIG. 4 is a schematic diagram showing a transformer system for electrical power distribution networks in accordance with embodiments;

FIG. 5 is a schematic diagram showing detailed connections in a transformer system in accordance with embodiments; and

FIG. 6 is a schematic diagram showing further detail of the connections between power electronics and a trimming transformer in a transformer system in accordance with embodiments.

FIG. 7 is a flowchart showing an example of how plural effects may be implemented, in accordance with embodiments

### DETAILED DESCRIPTION

Embodiments disclosed herein provide systems for addressing some or all of the issues discussed above. Transformer systems in accordance with embodiments may comprise series-connected transformers coupled with power electronics and control software that may assist with control system stability through a variety of functions, including some or all of: voltage regulation, reactive power control, inter-phase balancing, and harmonic reduction. The power electronics and control software may act to control the operations of the series-connected transformers in an ongoing fashion; accordingly systems may be referred to as actively controlled transformer systems. Transformer systems in accordance with embodiments may additionally or alternatively provide power support by injecting power during periods of temporary low power supply from power distribution networks. Embodiments may also provide some or all of the above functionality in compact packages requiring limited installation time or space.

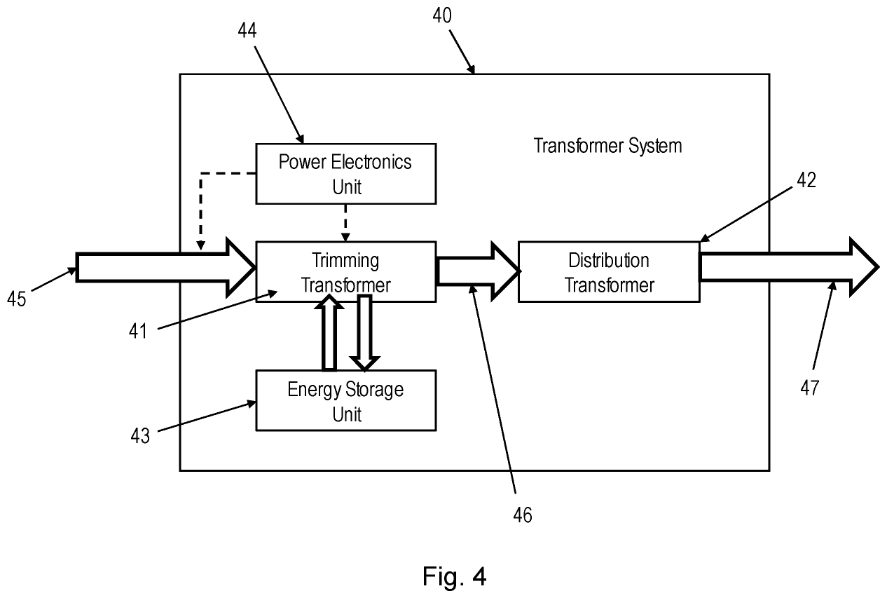

FIG. 4 is a schematic diagram showing a transformer system 40 for electrical power distribution networks in accordance with embodiments. The transformer system shown in FIG. 4 is an actively controlled transformer system and comprises a trimming transformer 41, a distribution transformer 42, an energy storage unit 43 and a power electronics unit 44. Input power from the power distribution network enters the transformer system 40 as indicated by the arrow 45 on the left of the figure, and then passes to the trimming transformer 41, which applies a correction voltage and correction current to the input power. The corrected power then passes from the trimming transformer to the distribution transformer as shown by arrow 46. The distribution transformer receives the (corrected) input power from the power distribution network and steps down the voltage from the distribution voltage to a regulated voltage; the regulated voltage is typically lower than the distribution voltage. The distribution transformer then outputs the regulated voltage, as shown by arrow 47 on the right of the figure, to a load (which may be domestic premises, businesses, and so as discussed above). Alternatively, the trimming transformer 41 may be positioned between the distribution transformer 42 and the load; where this is the case, the correction voltage and correction current may then be applied after the voltage step down from the distribution transformer, before the power is output to the load; here the trimming transformer may apply a correction voltage which results in the power output to the load being at a higher or lower voltage than the distribution voltage; the variation amount is determined by the capabilities of the trimming transformer, a typical example would be a ±10% change in the voltage from the distribution transformer. Of course, in configurations wherein the correction voltage and correction current are applied after the voltage step down from the distribution transformer, typical correction voltages may be lower and typical correction currents higher than where the correction voltage and correction current are applied between the power distribution network and the distribution transformer.

Typically, embodiments include some form of protection for the system (not shown in FIG. 4), such as one or more fuses and/or one or more closed contactors, on the input connection to the trimming transformer. The protective devices are intended to protect the system (and optionally also equipment upstream of the system) from damage in the event of power spikes due to, for example, lightning strikes. Embodiments may utilise series and shunt protection depending on the installation location and time between faults desired. The power connections to the inverter may also be fused to protect the substation from the inverter devices failing short. Switches on individual lines may be provided to assist in the replacement of components. The function of the disconnect switch and fuses can be replaced or augmented by a breaker, rated at the rated power of the inverter—a 50 kVA inverter would have a breaker set to supply 50 kVA, that is, slow trip at a phase current of 75 A. An electronically tripped breaker with an overvoltage sensor can be used, and or an electronic shorting crowbar circuit similar to that used to short the drive if fast reaction is needed.

The correction current and correction voltage applied by the trimming transformer is determined by the power electronics unit, and utilises energy from the energy storage unit. Typically, the power electronics unit is controlled by control software, which dictates the operation of the power electronics unit. In order to determine the correction current and correction voltage to be applied by the trimming transformer, the power electronics unit monitors the properties of the input connection power (typically, at the input to the trimming transformer, which may be from the distribution transformer or from the power distribution network depending on the system configuration). In some embodiments, the properties to be monitored may include some or all of: the magnitude of the input connection power; the input connection voltage sign and magnitude; the input connection current magnitude; the input connection current phase; harmonic modulations in input connection current and/or voltage; input frequency; and power factor angle. In order to perform the monitoring of the input connection power properties, the power electronics unit may utilise least one current sensor and at least one voltage sensor that are connected to the power electronics unit. Where voltage and current sensors are used by the power electronics unit, these units may sample the analogue properties of the input connection power at a given periodicity in order to obtain digital measurements to be used by the power electronics unit. The periodicity at which the sampling takes place may vary between embodiments, and may be determined by a number of factors including the data throughput capabilities of the sensor(s), power electronics unit, and so on. Typically, the sampling periodicity is at least 5 kHz. By way of example, a sampling periodicity of 15 kHz may be used. The plural phases of the input power may be separately monitored. The control software may control the power electronics unit based on the monitored properties of the input connection power. In some embodiments, the control software may additionally respond to received commands, for example, from a network control system or remote operator. The commands may be received in any suitable way, such as using a wired or wireless connection to a network control system. Some embodiments may be configured to interact with one or more further transformer systems (either directly or via a network control system, for example) such that the transformer systems can operate in concert. In particular, the systems may effectively combine under supervisory control (for example, of the network control system) or autonomously (under control of the transformer systems themselves) to provide collective effects. The use of several systems operating in a coordinated fashion may bolster the collective effectiveness of the systems in supporting the power distribution network, allowing more efficient network operation.

The power electronics unit is configured to control at least one of the correction voltage and the correction current to provide one or more of: a voltage regulation effect; a power control effect; a phase balancing effect; a harmonic reduction effect; and a support effect. In embodiments where the power electronics unit is configured to provide a plurality of the effects, where restricted availability of stored energy in the energy storage unit means that not all effects may be implemented fully, the effects may be prioritised in different ways. In some embodiments the effects may be prioritised according to a predetermined priority order such that, for example, if phase balancing is prioritised above harmonic reduction, the available stored energy from the energy storage unit may be used to provide the best possible phase balancing with a lower priority given to harmonic reduction. Alternatively, equal priority may be applied to all of the plurality of effects the power electronics unit is configured to provide. The energy storage units may utilise any suitable energy storage means, for example, one or a plurality of Direct Current (DC) capacitors, one or a plurality of battery units, a combination of capacitors and battery units, and so on.

The means by which the power electronics and trimming transformer (using the energy storage unit) apply the correction voltage and correction current differs based on the number of phases in the multi-phase input connection power from the electrical power distribution network (for example, three phase). The application of the correction current and correction voltage to provide the desired effect(s) is typically split across the phases, as explained below.

In accordance with some embodiments, the transformer system may be configured to control each phase of the plural phase power input separately. Any suitable system may be used to control the phases, by way of example, each of the phases may be controlled using a Flexible Active Control Transmission System, FACTS, configured to allow adjustment of the properties of the phase. Where FACTS are used, a separate FACTS may be used for each phase of the plural phase power input. Further, where plural FACTS are present, one or more of the FACTS (potentially all of the FACTS) may comprise both a series converter and a shunt converter. In multiphase systems, series converters are typically connected in series with individual phases and shunt converters are connected between phases. Presence of both series and shunt converters in FACTS used with phases of the plural phase power input can be particularly beneficial in scenarios wherein the power flow direction may be reversed, that is, wherein bidirectional power flow is possible.

In known transformer systems, series converters are commonly used for active power management and shunt converters are commonly used for reactive power management; this configuration may restrict the ability of known transformer systems to react to reversals of power flow direction. In scenarios where bidirectional power flows may be present, FACTS with both series and shunt converters may be configured such that the converters switch control roles with power flow direction reversals, increasing the efficiency with which the transformer system can accommodate power flow directional reversals. The series and shunt converters may additionally or alternatively be capable of switching roles in scenarios other than power flow directional reversals, where such switching would provide beneficial effects (such as increased efficiency) to the system. An example of a scenario wherein power may flow from the load side of the transformer system to the distribution network side is where there is significant power generation at the load side, for example, due to residential scale solar power and/or wind power generation.

By way of example, in systems wherein plural FACTS are used, one or more of the FACTS comprising both series and shunt converters, the FACTS comprising both converters may use one of the following configurations:
Series converter controls energy storage and/or active power; shunt converter controls active and/or reactive power,
Series converter controls energy storage and/or reactive power; shunt converter controls. active and/or reactive power,
Series converter controls active and/or reactive power; shunt converter controls energy storage and/or reactive power,
Series converter controls active and/or reactive power; shunt converter controls energy storage and/or active power.

The following text discusses how effects such as phase balancing, voltage regulation, power factor correction, harmonics reduction and power support may be provided; subsequently a discussion of particularly beneficial ordering of the effects is provided.

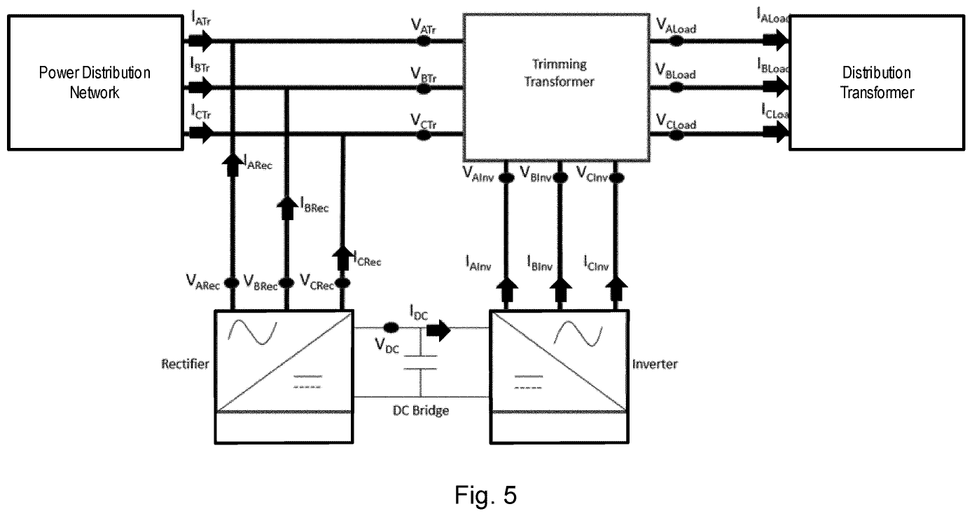

FIG. 5 is a schematic diagram of a transformer system showing in more detail an example of the connections between the trimming transformer, power electronics and input connection power from the electrical power distribution network, in accordance with some embodiments. In the FIG. 5 example, the trimming transformer is located between the electrical power distribution network and the distribution transformer, and the input power connection from the power distribution network is a three-phase connection.

FIG. 5 is a schematic diagram showing a trimming transformer series connected between a three-phase input connection from a power distribution network and a distribution transformer; the onward connection from the distribution transformer to a load (for example, domestic or business premises) is not shown. Also shown in FIG. 5 are two AC/DC converters; in this case a rectifier and an inverter, that are connected by a DC bridge (formed from capacitors). The AC/DC converters and the DC bridge form part of the power electronics in the example shown in FIG. 5. FIG. 5 does not show the control software controlling the power electronics, nor the protective devices.

In FIG. 5, the three phases are referred to as A, B and C. Several voltages and currents are labelled in FIG. 5, these include: V_{DC}—The voltage on the DC bridge; I_{DC}—The current on the DC bridge; V_{ABCTr}—The voltage on phase A, B, C (respectively) of the input connection to the (trimming) transformer from the power distribution network; I_{ABCTr}—The current on phase A, B, C of the input connection to the (trimming) transformer from the power distribution network; V_{ABCRec}—The voltage on phase A, B, C of the rectifier; I_{ABCRec}—The current on phase A, B, C of the rectifier; V_{ABCInv}—The voltage on phase A, B, C of the inverter; I_{ABCInv}—The current on phase A, B, C of the inverter; V_{ABCLoad}—The voltage on phase A, B, C of output from the trimming transformer to the distribution transformer and on to the load; I_{ABCLoad}—The current on phase A, B, C of output from the trimming transformer to the distribution transformer and on to the load. In order to provide the desired effects the power electronics is configured to calculate separately for each phase correction currents and correction voltages to be applied to the three phases (A, B, C). In some embodiments, the correction voltages and correction currents are calculated as vector sums. The calculation of the correction voltages and correction currents may be performed using any suitable calculation method, in particular, smart algorithms or trained machine learning (ML) models may be used to calculate the correction voltages and correction currents.

In some embodiments where the correction voltages and correction currents are implemented using FACTS, separate smart algorithms/ML models may be used to control the FACTS, thereby supporting the use of different corrections to different phases. By considering the different phases of input power separately, a finer degree of control may be provided and effects such as load balancing may be implemented more effectively; this is best explained by way of example. If a scenario is considered in which, for a three phase system, it is desired to implement a +5% voltage step up to one phase, no voltage change to a second phase, and a −5% voltage step down to a third phase. Where there is a lack of control between phases, an equal change (for example, a +5% voltage step up) may be applied to all phases. By contrast, where individual phase control is available, the phases can be separately adjusted. Individual control of phases may be particularly beneficial where bidirectional power may be present. In a scenario where power is generated at the load side of the transformer system, it is possible that there may be an excess of power on one or more of the phases of a multiphase system and a deficit on one or more of the other phases. In this scenario, power can be shifted from a phase with excess power to those operating at a deficit (that is, those acting as a load to the power distribution network), thereby both reducing the drain on the power distribution network and efficiently utilising the locally generated power. Local use of locally generated power in this way may reduce the number of instances during which it is necessary to deactivate local power generation sources (for example, to avoid excessive voltages), which may otherwise be necessary during periods of high local power generation (due to high winds or intense sunlight, for example).

Continuing with the FIG. 5 example, voltage regulation effects may be provided using the V_{ABCInv} connections. Using the V_{ABCInv} connections, the power electronics and trimming transformer may eliminate any fluctuations in the voltage delivered from the power distribution network (or from the load side where power flow direction has been reversed), ensuring that the distribution transformer receives a constant voltage. Taking the example of phase A, the voltage received by the distribution transformer V_{IALoad} is given by V_{IALoad}=V_{ATr}+V_{AInv}, where V_{ATr} is the input connection voltage to the trimming transformer and V_{AInv} is the correction voltage from the power electronics (specifically, in the FIG. 5 example, the inverter). Where the input connection voltage is at the intended level (referred to herein as the reference voltage level), no correction voltage may be required; where this is not the case the power electronics can provide the necessary correction voltage to be applied at the trimming transformer. Where locally generated power (reactive power in this scenario) is available at the load side, this may be used to reduce or increase the voltage on each phase as required. Where reactive power is not available, or is not sufficient to effect the voltage change required, power from the power distribution network (also referred to as real power or active power) may be used to change voltages on the phases as required.

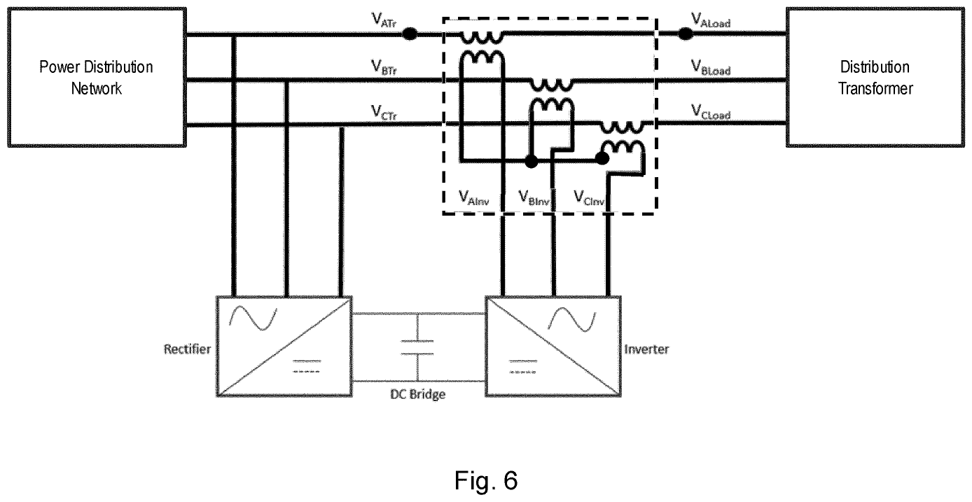

FIG. 6 is a schematic diagram showing further detail of the connections between the power electronics and the trimming transformer in the FIG. 5 example; in particular, the windings of the trimming transformer are shown in FIG. 6. As the correction voltage from the power electronics (specifically, the inverter) relies on the trimming transformer's ratio, the system may be scaled for any voltage level. The inverter voltage, V_{AInv}, is produced by a signal from the control software. A reference voltage is created by the control software based on the target power distribution network voltage and any difference between this reference voltage and measured, actual voltage, V_{ATr}, is compensated for by a signal from the control software to the inverter. Once this inverter voltage, V_{AInv}, is induced, the required voltage is obtained to produce V_{IALoad} and voltage regulation is thereby provided. The same process may be repeated in respect of the other phases (B and C). The intended result is a constant, desirable voltage produced at the output of the trimming transformer, regardless of fluctuations in the power distribution network voltage provision.

Returning to the FIG. 5 example, power control may be provided by the injection of current into the trimming transformer input. The input power received at the trimming transformer input (from the power distribution network) is at a high voltage and comparatively low current; after passing through the trimming transformer and distribution transformer, the power will be at a lower voltage and higher current. Accordingly, by injecting current at the input to the trimming transformer, rather than after the voltage has been transformed by the distribution transformer (for example), the amount of current to be injected to effect power control may be reduced, and the energy storage unit reserves may be conserved. Equally, where power is received from the load side, this will be at a lower voltage and higher current than after passing via the distribution transformer to the power distribution network.

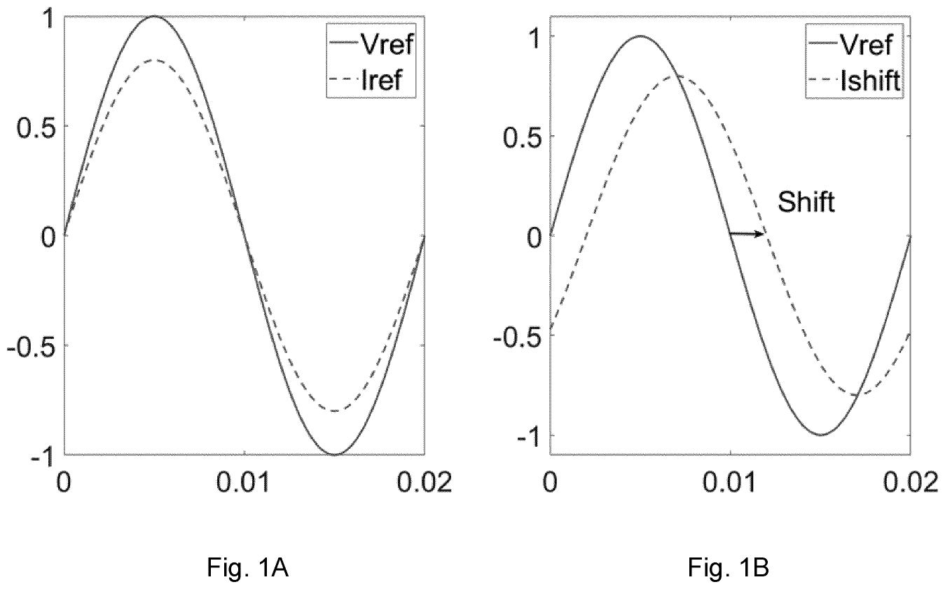

The power control effect may be supported by the power electronics, specifically the rectifier. Again using phase A as an example (and with reference to FIG. 5), the equation of importance is: I_{ARec}=I_{IALoad}−I_{ATr}. The load (via the distribution transformer) consumes reactive power meaning at the input connection from the power distribution network, the voltage, V_{ATr}, and current, I_{ATr}, are out of phase. FIG. 1A shows a power factor of unity; in order to achieve this, the power electronics (in this example, the rectifier) must produce a current that supplies the difference in phase between the voltage and current. Measuring V_{ATr}, the control software can create a reference for the phase of the rectifier current, I_{ARec}. The magnitude of the rectifier current I_{ARec} is then produced using as set out above. The rectifier current may then cancel the phase difference between V_{ATr} and I_{ATr}, thereby providing reactive power control.

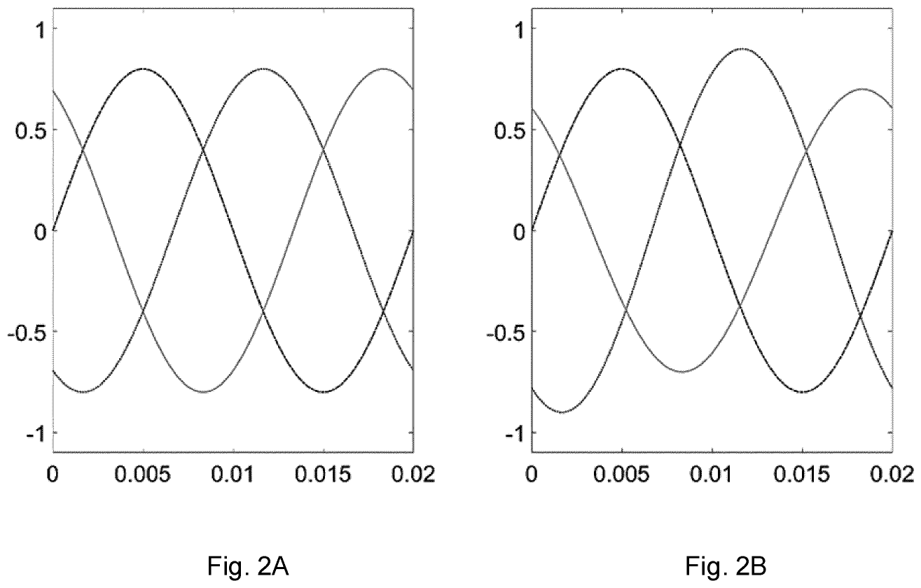

Phase balancing effects may also be provided for embodiments wherein the input power has multiple phases, such as the example shown in FIG. 5. As discussed above, FIG. 2A shows a system with three balanced phases. The trimming transformer in conjunction with the power electronics (in particular the rectifier) may balance unbalanced phases. The normalised current is given by

$${I}_{LoadNom} = \frac{{I}_{ALoad} + {I}_{BLoad} + {I}_{CLoad}}{3} .$$

Once the normalised current is determined, this represents the target current that each load current should have on either phase A, B, or C. In the FIG. 5 diagram, I_{ALoad}, I_{BLoad}, and I_{CLoad} may then each be replaced with |LoadNom. Each current to the distribution transformer (ALoad, I_{BLoad}, and I_{CLoad}) is measured and compared against this nominal load current that has been calculated. The rectifier then receives a signal to provide for the difference between the phase's measured current and the ideal current I_{LoadNom}. This functionality works the same across all three phases such that each phase's load current is now the ideal value. In this way, phase balancing is may be provided. Where the current values of one or more of the phases vary over time, the current provided by the rectifier may vary to provide the required balancing. A numerical example (which, for simplicity, assumes constant current values for the phases) is provided as follows.

An example unbalanced system could have the following values for I_{ABCLoad}:

$${I}_{A Load} = 30 A {I}_{B Load} = 31 A {I}_{C Load} = 35 A$$

### Using

$${I}_{L o a d N o m} = \frac{{I}_{ALoad} + {I}_{BLoad} + {I}_{CLoad}}{3}$$

to determine the ideal value, I_{LoadNom}, to achieve a balanced system:

$${I}_{LoadNom} = \frac{30 + 31 + 35}{3}$$

$${I}_{LoadNom} = 32 A$$

Each load current on each phase must now equal 32 A to achieve a balanced system. The control software therefore sends a signal to the rectifier to provide the required current to achieve this 30 A. Using I_{ABCTr}+I_{ABCRec}=I_{LoadNom} for each phase where I_{ABCTr}=I_{ABCLoad}, I_{LoadNom}=32 A and re-arranging for I_{ABCRec}:

$${I}_{A B C R e c} = {I}_{LoadNom} - {I}_{A B C T r}$$

Therefore, using Equation 5, each rectifier current for phases A, B, and C are calculated:

$${I}_{A R e c} = 32 - 30 = 2 A$$

$${I}_{B R e c} = 32 - 31 = 1 A$$

$${I}_{C R e c} = 32 - 35 = - 3 A$$

The above are the values that the control software signals to the rectifier to provide such that LoadNom=32 A on each of the three phases. To confirm, substituting in each I_{ABCRec} value:

$${I}_{A T r} + {I}_{A R e c} = {I}_{LoadNom} \qquad ( 4 )$$

$$30 + 2 = 32 A$$

$${I}_{B T r} + {I}_{B R e c} = {I}_{LoadNom}$$

$$31 + 1 = 32 A$$

$${I}_{C T r} + {I}_{C R e c} = {I}_{LoadNom}$$

$$35 - 3 = 32 A$$

Thus, it can be seen that once the rectifier supplies the required current, each phase of this example now has the required I_{LoadNom} value of 32 A to achieve phase balancing.

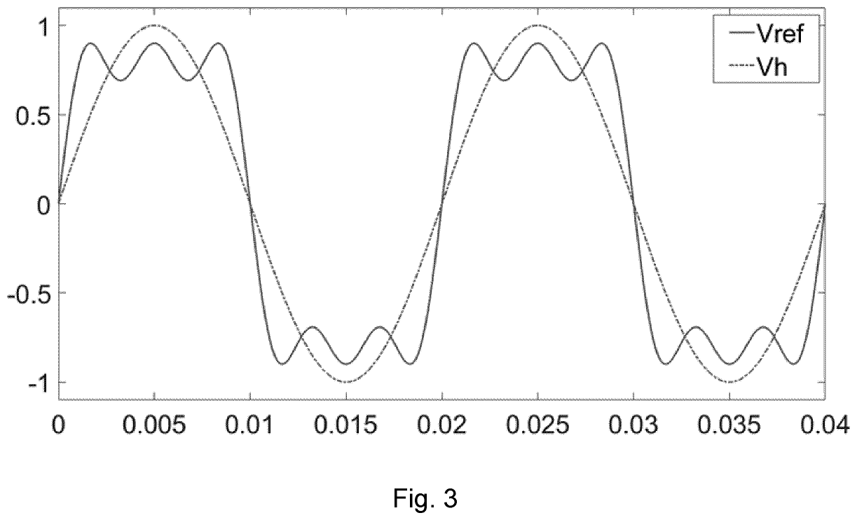

Harmonic reduction effects may additionally or alternatively be provided. An example of harmonic distortion is shown in FIG. 3, as discussed above. As can be seen in FIG. 3 the ideal, sinusoidal voltage waveform (Vₕ) is distorted by the presence of harmonics, resulting in the harmonic modulated voltage waveform (V_{ref}). As explained above, harmonics present on the load side may result in poor quality power being drawn from the distribution transformer. A consequence of this poor quality power being drawn by the distribution transformer is that the distribution transformer draws poor quality power from any assets in the grid before it, like the hundreds of miles of transmission lines that can precede these transformers. This will result in terrible inefficiencies from whichever generation point delivers the power to this transformer. The target then, is for the system to draw power that is free from harmonics.

Typically, loads on systems will always draw harmonics as a result of the devices that are in the homes or businesses that are connected within them (domestic appliances, industrial machinery, and so on). Therefore, to ensure that the I_{ABCTr} remains free from harmonics, and thereby to avoid poor generation efficiencies, the rectifier may provide the harmonics that the load wants to draw.

To achieve the ideal, smooth, sinusoidal waveform on I_{ABCTr}, the rectifier can help to greatly suppress these harmonics. The current on the load side of the trimming transformer, I_{ABCLoad}, is measured and compared with reference to the fundamental component of its waveform. In this way the harmonics that are present are extracted by the control software of the power electronics. A command is then sent to the rectifier to inject the required harmonics. Using I_{ALoad}=I_{ATr}+I_{ARec}, I_{ABCLoad} is provided but with the harmonics provided by the rectifier instead of the power distribution network. Accordingly, harmonics drawn from the power distribution network may be avoided.

Support effects may also be provided by embodiments, such as the example shown in FIG. 5. In situations wherein there is an increase or decrease in the power levels supplied by the power distribution network (relative to the desired levels) over a period of several minutes or longer, embodiments may direct excess power to the energy storage unit or provide the power shortfall from the energy storage unit. In order to do so, the necessary power addition/subtraction may be executed using the power electronics, for example and with reference to FIG. 5, by adjusting the levels of I_{ABCInv} and V_{ABCInv}.

Some or all of the above effects may be provided in accordance with embodiments. In some embodiments, plural effects may be provided. Where plural effects are to be provided, the system efficiency may be increased by applying the effects using a particular time ordering. By way of example, where all of a phase balancing effect, voltage regulation effect (using reactive power and using active power), power factor correction effect and harmonic reduction effect are to be provided, the efficiency of the system may be increased by providing the effects in that listed order, on a phase by phase basis.

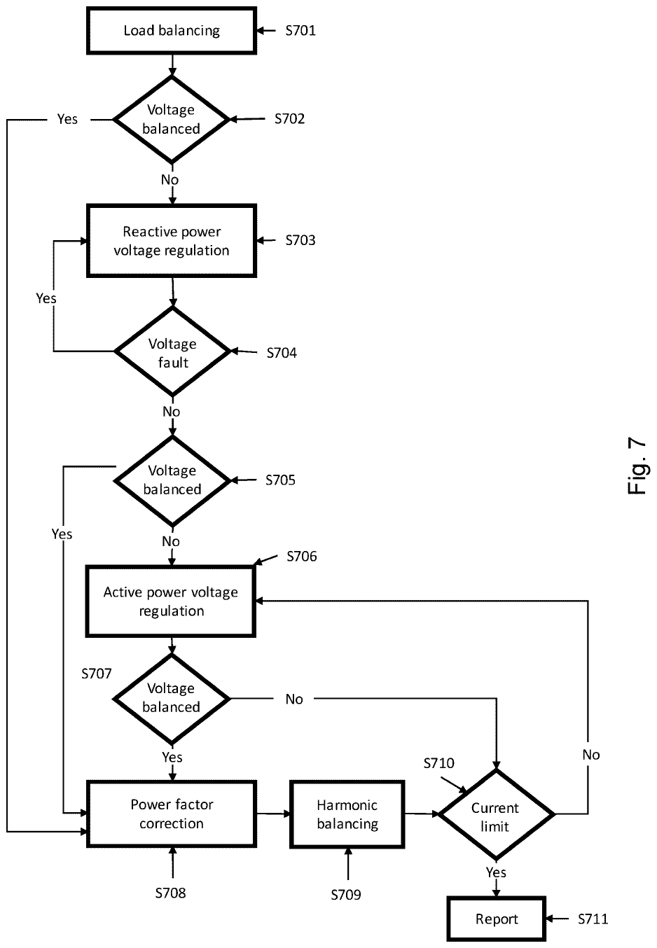

FIG. 7 is a flowchart illustrating an example of how plural effects may be implemented, in accordance with embodiments. As shown in step S701 embodiments may first implement a load balancing effect. The load balancing effect injects or absorbs active and/or reactive current as to take the phase load within current limits. Subsequently, as shown in step S702, the requirement for voltage balancing may be checked. Where the voltage is balanced, the process may move on the power factor correction (as shown in step S708); where this is not the case reactive power voltage regulation may then be implemented (see step S703). The reactive power voltage regulation effect injects or absorbs reactive power to reduce/increase the voltage as needed on each phase independently; this process may be repeated in the event of a voltage fault (Yes at step S704). If a further compensation is needed (No at step S705), then as discussed above the voltage regulation effect may be provided by injecting or absorbing active power to reduce/increase the voltage as needed on each phase independently until compensation is achieved (if voltage balance is still not achieved, No at step S707, the process may continue until the current limit is reached). If an undervoltage or overvoltage fault is detected, reactive power may be injected or absorbed up to the current/voltage limitations; in this scenario the power factor correction may be disabled to inject/absorb reactive power if the fault persists. The voltage support effect many be continued until the fault clears.

When voltage balance is reached, power factor correction may then be implemented (see step S708). The Power factor correction effect injects or absorbs reactive power to supply capacitive or inductive loads, independently at each phase, by bringing the power factor (as seen by the power distribution network) to 1. In some embodiments, if the power factor correction results in an increase of voltage as seen by the loads this effect may be omitted. Subsequently, harmonic balancing may be implemented (see step S709). As discussed above, some of the above processes (particularly voltage balancing) may result in the current limit being reached; where this is the case, a report may be transmitted to a network controller (see step S711).

In some embodiments, the transformer system may be configured to receive information relating to the operation of the power distribution network, such as frequencies, voltages and/or currents, and may additionally or alternatively receive information relating to the operation of load, such as frequencies, voltages and/or currents. The information may relate to multiple points across the power distribution side and/or load side of the transformer system. The information may be monitored directly by the transformer system, for example using a network of sensors, or may be transmitted to the transformer system in power status reports via a transceiver, as discussed herein. The information may be used by the transformer system in a reactive mode, wherein one or more effects is provided in response to a measured event comprising the detection of an issue (low voltage, phase imbalance, and so on). In some embodiments, particularly where a trained machine learning model is utilised as discussed above, the transformer system may additionally or alternatively operate in a predictive mode. When operating in a predictive mode, the transformer system may use the received information to predict future events, by way of example, to predict a future change in load voltage, and may pre-emptively apply one or more effects to mitigate the impact of the future event. In some embodiments the reactive or predictive event management may be implemented in conjunction with one or more further transformer systems; the plural transformer systems acting in concert (either under supervisory control of a network controller or autonomously) may provide collective network effects.

As discussed above embodiments may provide monitoring of voltage and currents (including fault current levels) for system control, and additionally or alternatively for logging and reporting of these over a wired or wireless communication link to a utility server or third-party data management service. The effects provided by the system can also be monitored and reported. The reporting information may include one or more of load balancing between phases, power factor correction, harmonic current suppression, voltage control, frequency response and inertia provided by voltage variation, amount of frequency response and inertia response available at any instant, and so on. The energy dissipated in losses from the control system can also be estimated and reported. Additionally or alternatively a wired or wireless link may be used to support changing of setpoints and control parameters to adjust the behaviour of embodiments, direct changes of effective tap ratio, allocate priorities between the different effects if available electronics power capability is limited, provide facilities for uploading of new versions of some or all parts of the control and monitoring code, and so on. In some embodiments, power control instructions may be received using a transceiver, and power control reports (both as discussed above) may be sent using a transceiver. Where higher security is required, these changes may be made available locally (at the system) only.

Embodiments support the provision of correction currents and correction voltages to the power input connections of distribution transformers, wherein the correction currents and correction voltages may provide one or a plurality of effects. The effects, individually or cumulatively, may increase the stability of power supply to users and may also protect other components of the power distribution network from negative effects caused by load properties. Through mitigation or minimisation of inefficiencies in networks, embodiments may support an increase in the capacity of existing power distribution network infrastructure. Systems may be installed on site and controlled/adjusted remotely, supporting rapid reconfiguration. By providing multiple effects, systems may also save space relative to installing multiple known systems each to address a smaller number of effects.

Embodiments may allow increased speed of response to voltage changes, and may additionally or alternatively allow the prediction of events (thereby allowing preparations for said events to be undertaken). Embodiments may provide support for bidirectional power flow scenarios, facilitating increased usage of energy from load side sources such as photovoltaic sources, wind sources, and so on.

Where independent control is provided for each phase of plural phase power systems, a high degree of fine control and configurability of the power may be provided by the transformer system. With sufficient co-ordination between the control functions, voltage/current compensation may be generated with a phase angle that is controllable throughout the full range of 360° regulation at its point of connection independently of the power being transferred, subject only to voltage and current rating limits.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A transformer system for electrical power distribution networks, the transformer system comprising:
a trimming transformer configured to receive at an input connection power from an electrical power distribution network at a distribution voltage, to apply a correction voltage and a correction current to the input connection power and to output at an output connection corrected power;
a distribution transformer connected in series with the output connection of the trimming transformer and configured to receive the corrected power from the trimming transformer and to output electrical power at a regulated voltage;
an energy storage unit connected to the trimming transformer and configured to receive energy from the trimming transformer and store the received energy, and to provide energy to the trimming transformer from stored energy; and
a power electronics unit configured to monitor the input connection power from the electrical power distribution network, and to control the correction voltage and the correction current applied by the trimming transformer based on the properties of the monitored input connection power wherein the power electronics unit is configured to control at least one of the correction voltage and the correction current to provide one or more of:
a voltage regulation effect;
a power control effect;
a phase balancing effect;
a harmonic reduction effect; and
a support effect.

2. A transformer system for electrical power distribution networks, the transformer system comprising:
a distribution transformer configured to receive at an input connection power from an electrical power distribution network at a distribution voltage and to output electrical power at a regulated voltage;
a trimming transformer connected in series with the output connection of the distribution transformer and configured to receive at an input connection the output power at the regulated voltage from the distribution transformer, to apply a correction voltage and a correction current to the input connection power and to output at an output connection corrected power;
an energy storage unit connected to the trimming transformer and configured to receive energy from the trimming transformer and store the received energy, and to provide energy to the trimming transformer from stored energy; and
a power electronics unit configured to monitor the power at the trimming transformer input, and to control the correction voltage and the correction current applied by the trimming transformer based on the properties of the monitored input connection power wherein the power electronics unit is configured to control at least one of the correction voltage and the correction current to provide one or more of:
a voltage regulation effect;
a power control effect;
a phase balancing effect;
a harmonic reduction effect; and
a support effect.

3. The transformer system of claim 1, wherein the power electronics unit is configured to monitor at least one of:
the magnitude of the input connection power;
the input connection voltage sign and magnitude;
the input connection current magnitude;
the input connection current phase;
harmonic modulations in input connection current and/or voltage;
input frequency; and
power factor angle.

4. The transformer system of claim 1, wherein the power electronics unit is connected to at least one current sensor and at least one voltage sensor, and wherein the power electronics unit is configured to utilise the at least one current sensor and at least one voltage sensor to monitor the input connection power.

5. The transformer system of claim 4, wherein the power electronics unit is configured to periodically monitor the input connection power, optionally wherein the monitoring is performed with a periodicity of 15 kHz.

6. The transformer system of claim 1, wherein the input connection is a three-phase connection and the trimming transformer is configured to receive three phase power via the three-phase connection.

7. The transformer system of claim 6, wherein the correction current and connection voltage to be applied by the trimming transformer are calculated by the power electronics unit as vector sums configured to provide the one or more effects.

8. The transformer system of claim 1, wherein the transformer system is configured to control each phase of a plural phase power input separately.

9. The transformer system of claim 8, wherein for each phase of the plural phase power input the transformer system comprises a Flexible Active Control Transmission System, FACTS, configured to allow adjustment of the properties of the phase.

10. The transformer system of claim 9, wherein at least one of the FACTS comprises a series converter and a shunt converter.

11. The transformer system of claim 10, wherein the series converter and shunt converter are configured to control energy storage and/or active power and/or reactive power.

12. The transformer system of claim 11, wherein the transformer system is configured to provide bidirectional power control, and wherein the series converter and shunt converter are configured to be capable of switching control roles.

13. The transformer system of claim 9, wherein the power electronics unit is configured to use a separate algorithm to control the adjustment of the properties of each phase.

14. The transformer system of claim 13, wherein the system is further configured to measure power distribution network and load frequencies, voltages and currents, and to respond to predicted events and/or measured events.

15. The transformer system of claim 14, wherein the response comprises providing a plurality of stabilising effects.

16. The transformer system of claim 15, configured to implement stabilising effects in the predetermined priority order: a phase balancing effect; a voltage regulation effect using reactive power; a voltage regulation effect using active power; a power factor correction effect; and a harmonic reduction effect.

17. The transformer system of claim 1, wherein the power electronics unit is configured, in the event of restricted available stored energy in the energy storage unit to prioritise the effects based on the predetermined priority order.

18. The transformer system of claim 1, wherein the energy storage unit is configured to store the received energy using one or more Direct Current, DC, capacitors, and/or to store the received energy using one or more battery units.

19. The transformer system of claim 1, further comprising at least one fuse and/or at least one closed contactor on the input connection to the trimming transformer.

20. The transformer system of claim 1, further comprising:
a transceiver, wherein the transformer system is configured to initiate transmission of power status reports via the transceiver, and/or to receive power control instructions via the transceiver,
wherein the transformer system is further configured to combine under supervisory control or autonomously with one or more further transformer systems to provide collective network effects.

21. (canceled)
